(19) United States
(12) Patent Application Publication
(10) Pub. No.: US 2007/0068747 A1
(43) Pub. Date: Mar. 29, 2007

(54) Self-energizing sliding caliper

(75) Inventor: Manuel Barbosa, Novi, MI (US)

Correspondence Address: HARNESS, DICKEY & PIERCE, P.L.C., P.O. BOX 828, BLOOMFIELD HILLS, MI, 48303, US

(73) Assignee: Akebono Corporation (North America)

(21) Appl. No.: 11/236,755

(22) Filed: Sep. 27, 2005

(51) Int. Cl. F16D 55/08

(52) U.S. Cl. 188/72.7

(57) ABSTRACT

A disc brake caliper assembly has a support bracket, a caliper body, a first brake pad, a second brake pad, and an actuator. The caliper body is slidably supported on the support bracket. The first brake pad is adapted to apply a first engagement force to the rotary component. The second brake pad is pivotally supported by the caliper body and is adapted to apply a second engagement force to the rotary component. The actuator is supported by the caliper body and is operable to exert a drive force on the second brake pad. The drive force has a magnitude that is less than the second engagement force. Actuation of the actuator pivots the second brake pad into engagement with the rotary component and induces the caliper body to slide relative to the support bracket such that the first brake pad engages the rotary component.

### FIELD OF THE INVENTION

The present invention relates generally to a disc brake caliper assembly and, more particularly, to a self-energizing sliding disc brake caliper.

### BACKGROUND OF THE INVENTION

Sliding disc brake systems include a disc, often referred to as a rotor, and a caliper assembly. The disc is typically fixed to a wheel of a vehicle. The caliper assembly includes a caliper body slidably supported on a support bracket which is fixed on the vehicle. The caliper assembly is disposed on or near an edge of the disc and houses an actuator. The caliper assembly also includes a pair of brake pads. The actuator applies a force to the brake pads. The brake pads axially displace into engagement with the disc to create a torque on the disc in a direction opposite to its rotation.

Typically, the torque applied to the disc is dependent on the amount of force generated by the actuator and the coefficients of friction of each of the brake pads. Furthermore, the torque applied to the disc is generally directly proportional to the piston area and fluid pressure. Hence, larger area pistons, with the same pressure, generate more braking force. However, larger pistons are more expensive, require a bulkier caliper body, and require more energy to operate.

### SUMMARY OF THE INVENTION

The present invention provides a disc brake caliper assembly for providing braking torque to a rotary component. The caliper assembly includes a support bracket, a caliper body, a first brake pad, a second brake pad, and an actuator. The caliper body is supported on the support bracket for sliding displacement along an axis that is substantially parallel to a rotational axis of the rotary component. The first brake pad is pivotally supported by the caliper body and is adapted to apply a first engagement force to the rotary component. The second brake pad is supported by the support bracket and is adapted to apply a second engagement force, which is self energized, to the rotary component. The actuator is supported by the caliper body and is operable to exert a force on the first brake pad. The force has a magnitude that is less than a magnitude of the second engagement force. Actuation of the actuator pivots the first brake pad into engagement with the rotary component and due to the rotary drag force induces the caliper body to slide relative to the support bracket such that the second brake pad engages the rotary component.

Another aspect of the present invention provides a disc brake caliper assembly for providing braking torque to a rotary component comprising a support bracket, a caliper body, a first brake pad, a second brake pad, and an actuator. The caliper body is supported on the support bracket for sliding displacement along an axis that is substantially parallel to a rotational axis of the rotary component. The first brake pad is pivotally supported on the caliper body and is adapted to apply a first engagement force to the rotary component having a first magnitude. The second brake pad is supported by the support bracket and is adapted to apply a second engagement force to the rotary component in a direction that is substantially opposite from the first engagement force and having a second magnitude that is larger than the first magnitude. The actuator is supported by the caliper body and is operable to exert a drive force on the first brake pad. Actuation of the actuator pivots the first brake pad into engagement with the rotary component which, in turn, due to the rotary draft force induces the caliper body to slide relative to the support bracket such that the second brake pad engages the rotary component.

Another aspect of the present invention provides a disc brake assembly comprising a rotary component, a support bracket, a pair of slide pins, a caliper body, a first brake pad, a second brake pad, and an actuator. The rotary component includes an inboard face and an outboard face. The support bracket straddles a perimeter portion of the rotary component. The pair of slide pins extend from the support bracket. The caliper body is slidably supported on the pair of slide pins along an axis that is substantially parallel to a rotational axis of the rotary component. The first brake pad is pivotally supported by the caliper body to exert a first engagement force on the inboard face of the rotary component. The second brake pad is supported by the support bracket to exert a second engagement force on the outboard face of the rotary component. The second engagement force is larger in magnitude to the first engagement force. The actuator is supported by the caliper body and is operable to exert a drive force on the first brake pad. The drive force has a magnitude that is less than the second engagement force. Actuation of the actuator pivots the first brake pad into engagement with the rotary component which, due to the rotary drag force, induces the caliper body to slide relative to the support bracket such that the second brake pad engages the rotary component.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an inboard view of a disc brake assembly in accordance with the principles of the present invention;

FIG. 2 is an outboard view of the disc brake assembly of FIG. 1; and

FIG. 3 is a cross-sectional view of the disc brake assembly taken through line III-III of FIG. 1.

### DETAILED DESCRIPTION OF THE PREFERRED EMBODIMENTS

The following description of the preferred embodiment is merely exemplary in nature and is in no way intended to limit the scope of the invention, its application, or its uses.

With reference to the Figures, a disc brake assembly 10 in accordance with the present invention generally includes a disc 12 and a caliper assembly 14. The disc 12 is a generally circular metal plate having an inboard face 12a, an outboard face 12b, and a radial edge 12c. It is envisioned that the disc 12 includes a plurality of vents disposed between the inboard and outboard faces 12a, 12b to dissipate heat. The disc 12 is adapted to be fixed to a wheel or axle component of a vehicle such that the wheel, axle, and disc 12 all share a common rotational axis. The caliper assembly 14 receives a portion of the radial edge 12c of the disc 12. The caliper assembly 14 includes brake pads, which will be discussed in more detail below, that are operable to frictionally engage the faces 12a, 12b of the disc 12. This frictional engagement provides torque to the disc 12 in a direction opposite to its rotation, thereby braking the disc and ultimately the vehicle.

The caliper assembly 14 includes a caliper body 16, a support assembly 18, an actuator 20, an inboard pad assembly 22, and an outboard pad assembly 24. The caliper body 16 includes an inboard portion 26 and an outboard portion 28. The inboard portion 26 includes a cylinder bore 30 and a pair of slide pin bores 32a, 32b. The cylinder bore 30 contains the actuator 20.

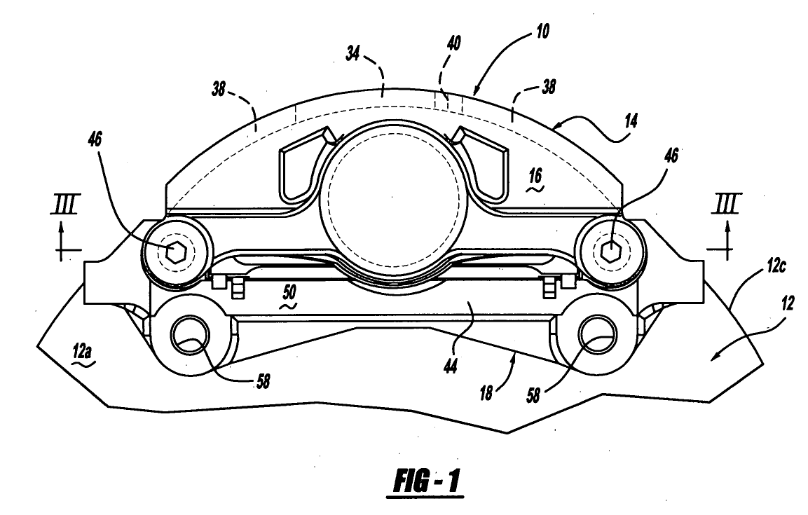

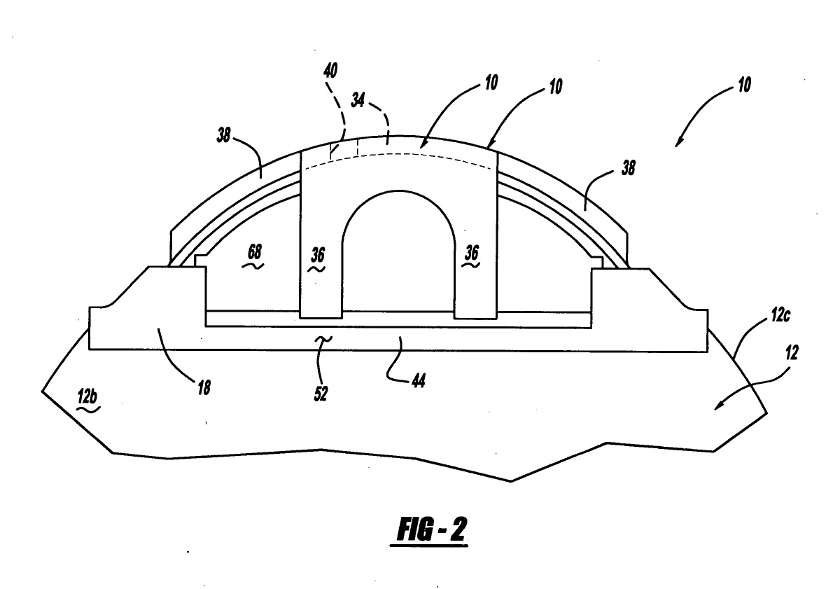

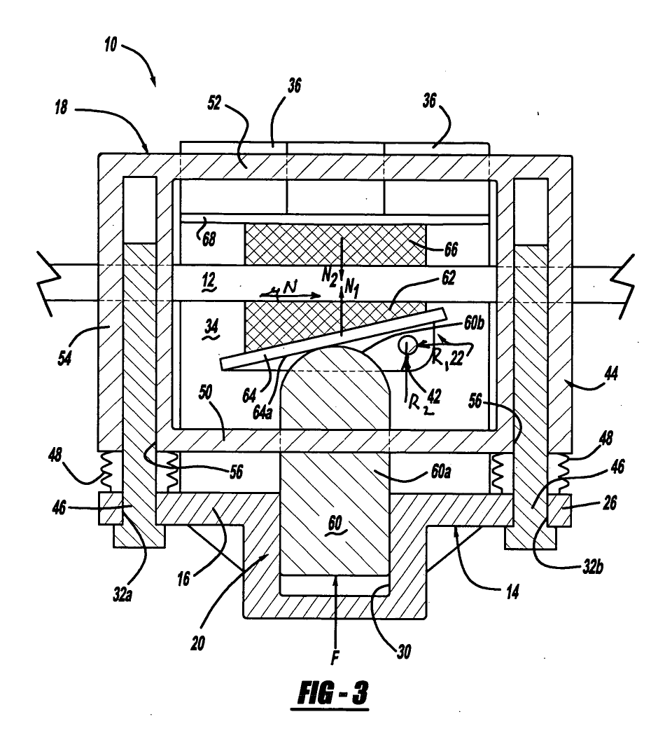

The outboard portion 28 of the caliper body 16 includes a bridge 34, a pair of bridge fingers 36, and a pair of support fingers 38. The bridge 34 is a semi-circumferential member having a substantially uniform radial thickness. The pair of bridge fingers 36 extend radially inward from the bridge 34. The bridge 34 also includes a radial bore 40 (shown in FIGS. 1 and 2) extending therethrough. The radial bore 40 receives a pin 42 (as shown in FIG. 3). In an exemplary embodiment, the pin 42 may include a rivet, a threaded bolt, a double-shear pin, or any other shaft like member capable of serving the principles of the present invention. The pair of support fingers 38 extend tangentially from opposite sides of the bridge 34 and engage portions of the support assembly 18.

FIGS. 1-3 depict the support assembly 18 including a support bracket 44, a pair of slide pins 46, and a pair of flexible boots 48. The support bracket 44 includes an inboard rail 50, an outboard rail 52, and a pair of opposing end rails 54. The inboard rail 50 is a generally elongated member including a pair of threaded blind bores 56 and a pair of fixture bores 58. The slide pins 46 each include threaded portions threadably engaging the blind bores 56 in the inboard rail 50 of the support bracket 44. Therefore, the slide pins 46 cantilever axially inward from the inboard rail 50. The slide pins 46 slidingly engage the slide pin bores 32a, 32b of the caliper body 16 to support the caliper body 16 relative to the support bracket 44. The flexible boots 48 are generally convoluted and constructed of rubber or another flexible material. The flexible boots 48 are disposed on the slide pins 46 between inboard rail 50 of the support bracket 44 and the caliper body 16. The flexible boots 48 prevent dust and/or debris from collecting on the slide pins 46 or in the slide pin bores 32a, 32b during operation of the brake assembly 10, as will be described in more detail below.

FIG. 3 depicts the actuator 20 including a piston 60 slidably disposed in the cylinder bore 30 of the caliper body 16. The piston 60 includes a shaft portion 60a and a domed portion 60b. The domed portion 60b engages the inboard pad assembly 22.

The inboard pad assembly 22 includes an inboard brake pad 62 and an inboard pressure plate 64. The inboard brake pad 62 is fixed to the inboard pressure plate 64. The inboard brake pressure plate 64 includes a plate portion 70 and an extending flange portion 72. The flange portion 72 include a pin receiving aperture 74. The plate portion 70 is angled with respect to the inboard disc surface 12a. The distance between the plate portion 74 and the disc at the pinned end (76) is less than the distance between the free end 78 of the plate portion 74 and the disc 12. Thus, the brake pad 62 is thinner at the pinned end 76 and thicker at the free end 78 so that the brake pad 62 face is planar and parallel to the disc face 12a.

The inboard pressure plate 64 is pivotally staked, via aperture 74, to the pin 42 fixed to the bridge 34 of the caliper body 16 and includes an engagement surface 82 on the back of the plate portion 70. The outboard pad assembly 24 includes an outboard brake pad 66 fixed to an outboard pressure plate 68. The outboard pressure plate 68 is slidingly supported on the opposing end rails 54 of the support bracket and adapted to be engaged by the pair of bridge fingers 36.

During operation, an external hydraulic source (not shown) applies a force F on the piston 60 disposed within the cylinder of the caliper body 16. This displaces the piston 60 toward the disc 12. The domed portion 60b of the piston 60 applies a force to the engagement surface 82 of the inboard pressure plate 64 causing the inboard pressure plate 64 and inboard brake pad 62 to pivot about the pin 42. The inboard brake pad 62 thereby frictionally engages the inboard face 12a of the disc 12 and applies a normal force N₁ thereto. This causes the caliper body 16 to displace inboard on the slide pins 38.

Since the brake pad 62 is hinged to the caliper body, the pad friction drag force is not absorbed by the support bracket. Thus, a force μN is created in a direction perpendicular to the force N₁. The pivot pin 42 exerts a force perpendicular to N₁ and at the same magnitude equal to μN. Due to the distance from the disc surface, and since the brake pad is pinned, a moment arm is created in the brake pad assembly. Thus, the force N₂ generated by the brake pad assembly 64 is greater than the force N₁ by μN. Thus, since the force N₂ is greater than the force of N₁, the brake pad 62 applies more force than is generated by the piston and thus becomes a self-energizing braking system. The force N₂ is counteracted by the force N₁ plus the normal force at the pin 42.

Due to the drag force, and due to the distance between the face of the disc and the pin, as well as the distance between the pin and the centroid of the brake, the amount of force applied by the brake 62 can be changed. Accordingly, this would enable a smaller piston to be used which, in turn, would apply the same amount of force as a larger piston having conventional brake pads.

Additionally, a pair of support fingers 38 extending from the sides of the bridge 34 of the caliper body 16 may transmit torque to the support bracket 54 via their engagement with the opposing end rails 54.

Furthermore, it should be appreciated that the present invention provides a cost effective caliper assembly 14 by utilizing a single pivoting inboard brake pad in combination with a typical sliding caliper body. Further yet, it should be appreciated that the caliper assembly 14 of the present invention minimizes deflection of the disc 12 during normal operation because the inboard and outboard pad assemblies 22, 24 apply substantially equal and opposite forces thereto.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A disc brake caliper assembly for providing braking torque to a rotary component, comprising:
a support bracket;
a caliper body slidably supported on said support bracket;
a first brake pad supported by the support bracket and adapted to apply a first engagement force to the rotary component;
a second brake pad pivotally supported by said caliper body and adapted to apply a second engagement force to the rotary component; and
an actuator supported by said caliper body and operable to exert a drive force on said second brake pad, said drive force having a magnitude that is less than a magnitude of said second engagement force, whereby actuation of said actuator pivots said second brake pad into engagement with the rotary component thereby inducing said caliper body to slide relative to said support bracket such that said first brake pad engages the rotary component.

2. The caliper assembly of claim 1 further comprising a pin attached to said caliper body for pivotally supporting said second brake pad.

3. The caliper assembly of claim 1, wherein said actuator includes a piston having an arcuate surface in substantially continuous engagement with said second brake pad.

4. The caliper assembly of claim 1, wherein said first engagement force includes a magnitude that is substantially equal to a magnitude of said second engagement force.

5. The caliper assembly of claim 1 wherein said caliper body includes a support finger abutting a portion of said support bracket.

6. The caliper assembly of claim 1 wherein said support bracket includes a pair of slide pins slidably supporting said caliper body.

7. A disc brake caliper assembly for providing braking torque to a rotary component, comprising:
a support bracket;
a caliper body supported on said support bracket for sliding displacement along an axis that is substantially parallel to a rotational axis of the rotary component;
a first brake pad supported by said support bracket and adapted to apply a first engagement force to the rotary component having a first magnitude;
a second brake pad pivotally supported by said caliper body and adapted to apply a second engagement force to the rotary component in a direction that is substantially opposite from said first engagement force and having a second magnitude that is substantially equal to said first magnitude; and
an actuator supported by said caliper body and operable to exert a drive force on said second brake pad, whereby actuation of said actuator pivots said second brake pad into engagement with the rotary component thereby inducing said caliper body to slide relative to said support bracket such that said first brake pad engages the rotary component.

8. The caliper assembly of claim 7 further comprising a pin attached to said caliper body for pivotally supporting said second brake pad.

9. The caliper assembly of claim 7, wherein said actuator includes a piston having an arcuate surface in substantially continuous engagement with said second brake pad.

10. The caliper assembly of claim 7, wherein said drive force includes a magnitude that is less than said second magnitude.

11. The caliper assembly of claim 7 wherein said caliper body includes a support finger engaging a portion of said support bracket to minimize deflection of said caliper body.

12. The caliper assembly of claim 7 wherein said support bracket includes a pair of slide pins slidably supporting said caliper body.

13. A disc brake assembly, comprising:
a rotary component including an inboard face and an outboard face;
a support bracket straddling a perimeter portion of said rotary component;
a pair of slide pins extending from said support bracket;
a caliper body slidably supported on said pair of slide pins along an axis that is substantially parallel to a rotational axis of said rotary component;
a first brake pad supported by said support bracket for exerting a first engagement force on said outboard face of said rotary component;
a second brake pad pivotally supported by said caliper body for exerting a second engagement force on said inboard face of said rotary component, said second engagement force being substantially equal in magnitude to said first engagement force; and
an actuator supported by said caliper body operable to exert a drive force on said second brake pad having a magnitude that is less than said second engagement force, whereby actuation of said actuator pivots said second brake pad into engagement with said rotary component thereby inducing said caliper body to slide relative to said support bracket such that said first brake pad engages said rotary component.

13. The disc brake assembly of claim 12 wherein said caliper body includes a support finger engaging a portion of said support bracket to minimize deflection of said caliper body.

14. The disc brake assembly of claim 12 wherein said actuator includes a piston having an arcuate surface in substantially continuous engagement with said second brake pad.

15. The disc brake assembly of claim 12 further comprising a pin attached to said caliper body for pivotally supporting said second brake pad.
